(19) United States
(12) Patent Application Publication
(10) Pub. No.: US 2013/0257804 A1
(43) Pub. Date: Oct. 3, 2013

(54) Method, apparatus, and system for capacitive touch communication

(71) Applicant: RUTGERS, THE STATE UNIVERSITY OF NEW JERSEY, New Brunswick, NJ (US)

(72) Inventors: Tam Vu, Highland Park, NJ (US); Richard Howard, Highland Park, NJ (US); Predrag Spasojevic, Highland Park, NJ (US); Marco Gruteser, Princeton, NJ (US)

(73) Assignee: RUTGERS, THE STATE UNIVERSITY OF NEW JERSEY, New Brunswick, NJ (US)

(21) Appl. No.: 13/853,899

(22) Filed: Mar. 29, 2013

Related U.S. Application Data
(60) Provisional application No. 61/617,144, filed on Mar. 29, 2012.

(51) Int. Cl. G06F 3/044

(52) U.S. Cl. CPC G06F 3/044
USPC 345/174

(57) ABSTRACT

A method, apparatus, and system for using a user device to communicate with a touch-screen of an electronic device includes generating, by an electronic circuit of the user device, a signal by encoding a data sequence that may be stored in a memory of the user device and communicating the signal from the user device, to the electronic device by varying a capacitance of the touch-screen thereof. The electronic device receives the signal to obtain the data sequence. The electronic device may use the data sequence to at least authenticate a user of the user device.

### REFERENCE TO RELATED APPLICATIONS

This application is a non-provisional application claiming priority to U.S. Provisional Patent Application Ser. No. 61/617,144 filed Mar. 29, 2012, which is hereby incorporated by reference as if fully disclosed herein.

### STATEMENT REGARDING FEDERALLY SPONSORED RESEARCH OR DEVELOPMENT

This invention was made with government support under Grant Nos. 0845896 and 1040735 awarded by the National Science Foundation. Accordingly, the U.S. Government has certain rights in this invention.

### FIELD OF THE DISCLOSURE

The present disclosure relates to data communications. More specifically, the present disclosure relates to the generation of touch events on a capacitive touch-screen of an electronic device to communicate information to the electronic device.

### BACKGROUND OF THE INVENTION

Touch-screen technology was first developed in the 1960's for air traffic control systems and is now a popular user interface technology on devices ranging from Automated Teller Machine (“ATMs”) and self-service terminals in grocery stores or airports, to cars, smart phones, and tablets. The touch pads used in laptops are based on similar technology. These products employ different touch-screen implementations, including analog resistive, surface capacitive, projected capacitive, surface acoustic wave, infrared and optical technology, and the like. On mobile devices, however, capacitive touch-screens have emerged as the primary user interface technology.

Mobile electronic devices now provide ubiquitous access to a vast array of media content and digital services. These devices can access email and personal photos, open cars or garage doors, pay bills and transfer funds between bank accounts, order merchandise, as well as control various functions within the home. These devices now provide the de-facto single sign-on access to a wide array of content and services.

As users increasingly rely on a variety of such devices, users tend to quickly switch between them and temporarily share them with others. Users may allow children to play games on smart phones or share a tablet with colleagues or family members. Sometimes a device may be used by several persons simultaneously, as when playing a multi-player game on a tablet. Occasionally, a device might fall into the hands of strangers.

In all these situations, it would be of great benefit for the device to know who is interacting with it and, occasionally, to authenticate the user. Users may want to limit access to age-appropriate games and media for children or prevent unauthorized or unwanted credit card charges. Users desire to hide sensitive personal information from strangers, colleagues, or curious family members. Or, users may simply want to enjoy an enhanced user experience from a multi-player game that can tell who touched the screen.

User identification and authentication mechanisms available on today's mobile electronic devices have been largely adopted from Personal Computer (“PC”) software and have not adapted to the versatility of the usage and sharing possibilities. For example, several mobile devices (e.g., smart phones) do allow the user to restrict access to device functions. The devices, however, do not provide any easy way to quickly change, let alone authenticate, users. They typically provide Personal Identification Number (“PIN”) codes or passwords for authentication, although a number of other techniques have been proposed. Yet they remain cumbersome and very few people enable these security features on their phones.

For example, DiamondTouch was proposed in 2001 as one of the first efforts toward differentiating touches of different users interacting with the same surface. (See P. Dietz and D. Leigh. Diamondtouch: a multi-user touch technology). In Proc. of UIST, November 2001, DiamondTouch uses a physical table to transmit capacitively coupled signals through users, chairs, and finally to the receiver. This approach requires extensive hardware infrastructure which make it impossible to apply to mobile scenarios. Signet uses physical patterns of conductive material as unique inputs for authentication through a capacitive touch screen. (See Erica Naone, Pushing the Limits of the Touch Screen, MIT Technology Review, Aug. 23, 2011 (available at http://www.technologyreview.com/hack/425130/pushing-the-limits-of-the-touch-screen/)).

There are several ways to authenticate a user, which in general can be divided into 1) what you know, 2) what you have, and 3) who you are. PINs, passwords and swipe patterns are the most widely spread authentication mechanism for mobile phones. These methods are easy to implement and require no special hardware, but are easily observable by an adversary and usually have very low information entropy. For example, the usual 4 bit numeric PINs used in most phones have a theoretical potential entropy of log₂(10⁴)=13.3 bits. Practical entropy for 4-digit PINs is likely to be much lower, as is the case with passwords. The second type of authentication mechanisms (“what you have”) are often also referred to as authentication tokens, examples include Magkey/Mickey, Radio Frequency Identification (“RFID”) or other wireless tokens such as transient authentication, and Infrared (“IR”) ring. Magkey and Mickey are tokens that use magnetic fields and acoustic signals that are received by the device's compass and microphone respectively. RFID, Near-Field Communications (“NFC”), and other wireless-based techniques are prone to eavesdropping and suffer from interference among multiple radio signal sources. And finally, IR ring demonstrated the possibility to use IR video cameras to authenticate users on a multi touch display, which is not directly applicable to today's mobile devices due to its additional hardware requirement.

Examples of “who you are” include iris recognition, face recognition, and voice recognition all of which are being actively prototyped and tested on mobile devices. Devices have been developed that include a finger print sensor and/or a finger-vein pattern matching technique. Both these techniques require specialized hardware which adds to the cost and form-factor of handheld devices and are prone to known vulnerabilities. On the other hand, face, iris, and voice recognition utilizes the in-built sensors and feature sets already implemented in mobile devices for other applications. While these techniques can leverage the abundance of past research in the respective fields, they also suffer from the well known spoofing mechanisms. For example, both high-quality photograph of the eye and printed contact lenses have been used to achieve close to 100% spoof acceptance rates for iris recognition systems. Face recognition systems can be compromised just by showing a picture taken with another smart phone. Similar results hold for face detection and voice detection although large strides are also being made for spoof detection in biometric authentication systems. More recently, innovative uses of the various sensors available in most smart phones have led to a number of unconventional techniques. For example, there are proposals for in-air gesture based authentication mechanism which uses the accelerometer sensors of the mobile device. Being easily visible to an adversary, such a scheme suffers from an unpleasant tradeoff between coming up with complex gestures and being susceptible to copy attacks, and can also be socially awkward. Implicit authentication is a similar approach which aims to authenticate mobile users based on everyday actions such as number/duration of calls, location, connectivity pattern, etc. and keeps a multi-variable continuous authentication score of the user. As is obvious, this requires a continuous modeling and logging of data from a variety of sensors and has a high energy cost.

Today's consumer electronic devices often include some form of parental control mechanisms, which are usually limited to locking out some functionalities of the device or service, e.g. adult content. Parental control mechanisms are an overlooked area of research, however, recent studies indicate that there would be demand for flexible access control mechanisms at home.

The problem of device pairing is also closely related to secure authentication and solution approaches often overlap. The general objective in this case is to enable two devices with no prior context to securely associate with each other in the presence of man-in-the-middle adversary. The short-range and frequency hopping nature of Bluetooth makes it a robust authentication mechanism, however several recent works expose a key vulnerability, i.e., passive sniffing of the PIN during the pairing process. Similarly, for NFC based pairing, eavesdropping using directional antennas has been shown to be a critical security threat. Novel use of the accelerometer sensor in mobile devices have recently been shown to provide a secure method of device pairing. While robust for two equipped mobile devices, the requirement of shaking prevents its use from cases which require pairing of a mobile device with a fixed device. Further, replication of the movement by an adversary is possible through careful observation of the pairing process. Finally, a recent approach uses public Radio Frequency (“RF”) signals such as Television (“TV”) and Frequency Modulation (“FM”) broadcasts to derive cryptographic keys for secure pairing between close-by devices.

Auxiliary channels to establish shared secrets have been studied extensively in the domain of secure pairing since the resurrecting duckling model. Examples include using infrared or humans. More recently secure pairing efforts have focused on using the same channel for authentication and data, and deriving the keying material based on the local environment.

### SUMMARY OF THE INVENTION

A system for capacitive touch communication is disclosed that includes a user device that stores a data sequence and an electronic device with a capacitive touch screen. The user device includes a memory for storing the data sequence and a processor configured to generate a signal by encoding the data sequence stored in the memory, and at least one electrode electrically coupled to the processor and configured to communicate the signal to the electronic device by varying the capacitance of the capacitive touch screen of the electronic device. Optionally, the signal may be modulated by the user device and demodulated by the electronic device.

The electronic device includes a second processor, a capacitive touch-screen, and a computer-readable storage medium. Instructions are stored on the computer readable medium that, when executed, cause the second processor to receive a sequence of touch events generated in response to the varying capacitance of the capacitive touch-screen caused by the user device. The instructions also cause the processor to demodulate the sequence of touch events to obtain the data sequence encoded by the user device, and authenticate a user of the user device using the data sequence.

A method for using a user device to communicate with a touch-screen of an electronic device includes generating, by an electronic circuit of the user device, a signal by modulating a data sequence stored in a memory of the user device and communicating the signal from the user device to the electronic device by varying a capacitance of the touch-screen thereof. The electronic device receives the signal to obtain the data sequence. Optionally, the electronic device uses the data sequence to at least authenticate a user of the user device. Alternatively, the electronic device may use the data sequence to identify and distinguish the user of the device from a different user not using the device and/or using a different device.

### BRIEF DESCRIPTION OF THE DRAWINGS

Embodiments will be described with reference to the following drawing figures, in which like numerals represent like items throughout the figures, and in which:

FIG. 1 is a schematic of an example capacitive touch screen;

FIG. 2 is a circuit diagram of an example internal touch detection circuit;

FIG. 3 is a diagram illustrating capacitive touch communication;

FIG. 4 is an example touch event data structure;

FIG. 5 is an example threshold selection algorithm;

FIG. 6 is an example of an calibration process;

FIG. 7 is a graph showing the number of events in bit 1 and bit zero for transmissions at 4 bits/s;

FIG. 8 is an example minimum distance demodulation algorithm;

FIG. 9A is a series of graphs showing type, size, and amplitude values generated by finger swipes without a wearable device;

FIG. 9B is a series of graphs showing type, size, and amplitude values generated by figure swipes with a wearable device;

FIG. 10 is a graph showing touch-screen responses;

FIG. 11A are graphs showing the detection rate and the false acceptance rate;

FIG. 11B is a graph showing multi-user detection rates;

FIG. 12 is a circuit diagram of an example wearable device;

FIG. 13 is a block diagram of an example system implementing the wearable device;

FIG. 14 is a block diagram of an example electronic device

FIG. 15 is a flow chart showing an example process;

FIG. 16 is a flow chart showing an example process; and

FIG. 17 is a flow chart showing an example process.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used in this document, a statement that a device or system is “in electronic communication with” another device or system means that devices or systems are configured to send data, commands and/or queries to each other via a communications network. The network may be a wired or wireless network such as a local area network, a wide area network, an intranet, the Internet or another network.

A “computing device” refers to a computer, a processor and/or any other component, device or system that performs one or more operations according to one or more programming instructions.

The term “data” may refer to physical signals that indicate or include information. A “data bit” may refer to a single unit of data.

An “electronic device” refers to a device that includes an imaging device, a processor and tangible, computer-readable memory. The memory may contain programming instructions in the form of a software application that, when executed by the processor, causes the device to perform one or more barcode scanning operations according to the programming instructions. Examples of suitable devices include portable electronic devices such as smart phones, personal digital assistants, cameras, tablet devices, electronic readers, personal computers, media players, satellite navigation devices and the like.

This document discloses a form of “wireless” communication, called capacitive touch communication, to address the shortcomings of conventional devices and techniques. The key idea is to exploit the pervasive capacitive touch screen and touchpad input devices as receivers for an identification code transmitted by a hardware identification token. While the token can take many forms, one scenario disclosed herein is a token taking the form of a ring, inspired by the signet rings used since ancient times. The token transmits electrical signals on contact with the screen, either direct contact or indirect contact through the human skin. In contrast to the short comings of conventional devices and techniques, the present disclosure focuses on using arbitrary programmable sequences of bits through direct use of the user's fingers. As such, it makes the solution to those short comings non-intrusive and applicable to wider classes of applications. The present disclosure also facilities the use of parental controls in a similarly non-intrusive manner.

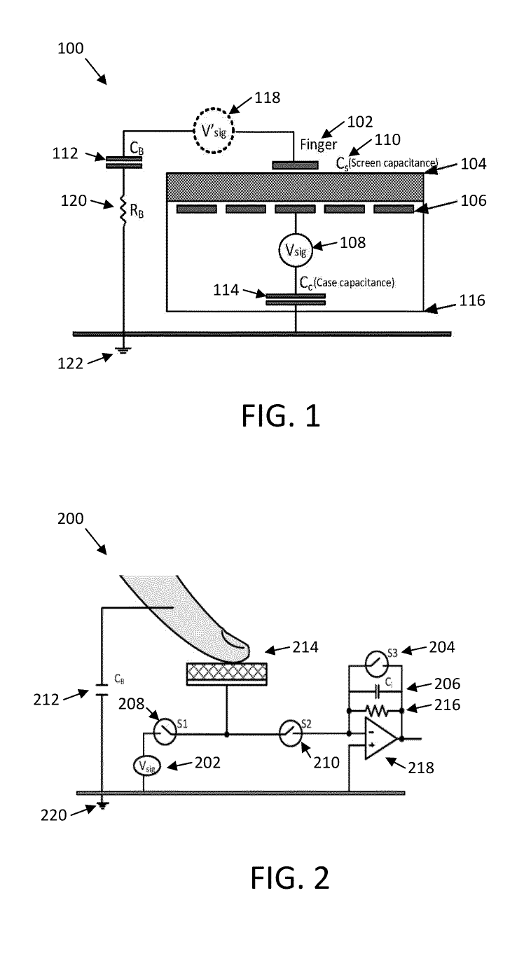

Referring now to FIG. 1, there is provided a schematic of one possible scenario of a capacitive screen system. A capacitive screen includes of an array of conducting electrodes 106 which detects a touch (e.g., by finger 102) by measuring the additional capacitance of a human body in the circuit. The electrode array is typically behind a transparent, insulating glass layer 104. The components are contained within device case 116.

In FIG. 1, when a user touches the screen, his/her finger 102 acts as the second electrode in a capacitor with the screen 104 as the dielectric between the finger 102 and an electrode array 106. The touch-screen electrodes 106 are driven by an Alternating Current (“AC”) signal 108 (“V_{sig} 108”) which sends a current through the screen capacitance 110 (“Cₛ”) passing through the body capacitance 112 (“C_{B}”), and then back into the device through the case capacitance 114 (“C_{c} 114”) of the device case 116. This change in V_{sig} 108 measured at one or more screen electrodes 106 is then passed to the screen controller (not shown) for processing. Because all of the relevant capacitance values are small (e.g., hundreds of picofarads), environmental noise makes direct measurement of this current impractical. Also present in FIG. 1 are the body resistance 120 and the ground 122.

Instead, the charge integration circuitry shown in FIG. 2 is used to measure the excess capacitance associated with a finger touch. In a scenario, a digital signal 202 (“V_{sig} 202”) may be synchronized with a pair of switches and a charge integrator. Switch 204 (“S₃ 204”) is first closed to discharge capacitor 206 (“Cᵢ 206”) and then opened. Switch S₃ 204 and capacitor Cᵢ 206 are attached in parallel with resistor 216 and amplifier 218. As with the system described in FIG. 1, the body ground 220 is also depicted. Next, switch 208 (“Sᵢ 208”) is closed and switch 210 (“S₂ 210”) is opened while V_{sig} 202 is high. This charges the series combination of the capacitor 212 (“C_{B} 212”), Cᵢ 114 of FIG. 1 (not shown in FIG. 2), and Cₛ 110 of FIG. 1 (not shown in FIG. 2). Then Sᵢ 208 is opened and S₂ 210 closed, transferring this charge to Cᵢ 206. This is commonly known as sample and hold operation. After a fixed number of cycles, the voltage on Cᵢ 206 is directly proportional to the ratio between Cᵢ 206 and the series combination C_{B} 212, C_{c} 114, and Cₛ 110. This voltage is then used to detect touch and, through the matrix addressing of the electrodes (e.g., 106 of FIG. 1), position of the touch 214. Hence, even when a finger is moved across the screen surface without lifting it, the finger triggers this detection at different positions on the electrode array.

While modifications to the touch sensor hardware and firmware can be made to facilitate such communication, the present invention i will be described herein in relation to scenarios in which communications are achieved with off-the-shelf touch sensor systems. Embodiments of the present invention are not limited in this regard. Operating without physical layer access imposes stringent requirements on the communication protocols, as discussed below. The disclosed scenarios offer a useful point solution within the design space of capacitive touch communication, since this approach would allow more rapid deployment on existing devices. Although it is assumed that a developer will only have access to the touch events exported by the screen's driver, and not the raw voltage measurements, the disclosed scenarios are not so limited. One of skill in the art will recognize that the core features of the disclosed scenarios may be implemented with or without direct access to physical layer signaling from the capacitive touch screen.

The disclosed scenarios take advantage of a technique for “spoofing” the screen detection algorithm by causing the system to alternately register touch/no touch conditions even when the finger is not moving. This allows a digital signal to be sent into the touch-screen.

Referring again to FIG. 1, one possible method for artificially creating touch events is by injecting a synchronized signal 118 (“V′_{sig} 118”) into the circuit with the proper amplitude and phase to increase or decrease the charge integrated on C, 206 of FIG. 2. Unfortunately, the signal in the device, V_{sig} 108, is not available to the external user, so such synchronization would be extremely difficult. As such, an unsynchronized lower frequency signal of high amplitude may be used which charges and discharges C, 206 asynchronously, leading to repetitive, but irregular, touch/no touch events captured by the touch screen controller. This process essentially “spoofs” the touch detection mechanism by injecting high level repetitive signals and introduces a technique to send a low bit rate signal into the tablet. With precise knowledge of the proprietary touch sensor systems it should be possible to create much more fine-grained signaling methods.

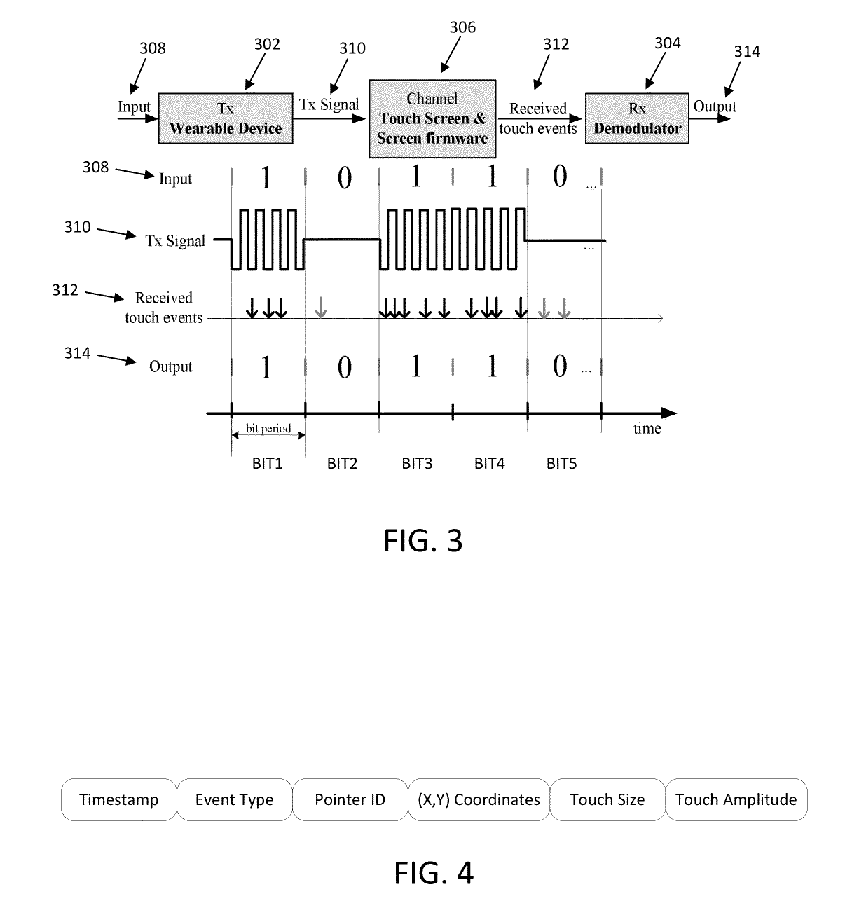

Referring now to FIG. 3, an example communication scheme is modeled as a classical communication system with a transmitter 302, a receiver 304, and a complex channel 306 connecting the two.

The transmitter 302 may be a wearable battery-powered hardware token. One possible form that such a token could take is that of a ring, essentially a digital version of the signet rings carried by nobility in earlier times. While many other forms of tokens are possible, we will use the ring concept as a running example throughout the paper. One skilled in the art will recognize, however, that the disclosed scenarios are not limited in this regard.

Transmitter 302 may contain a flash memory that stores a bit sequence and/or a message. In some scenarios, the bit sequence and/or the message may be stored in an unencrypted or an encrypted form. The message may be a user identifier or a secret key that authenticates a user, e.g. input 308. The transmitter 302 also comprises a processor that reads the bit sequence and generates am modulated signal. The modulated signal can include, but is not limited to, an amplitude modulated signal, a voltage modulated signal, and/or a frequency modulated signal. Each of the listed types of modulation signals is well known in the art, and therefore will not be described herein. In some scenarios, a special type of amplitude modulation called amplitude shift keying (or On-Off keying (“OOK”)) modulated signal may be used.

In the OOK modulation scenario, bit one of input 308 is represented by turning on a carrier signal 310. Bit zero is represented by switching off that carrier signal 310. The OOK modulation signal resulting from such on/off switching is shown in FIG. 3 as transmission (“Tx”) signal 310. When the ring is pressed against the screen, it acts as a voltage source (e.g., V′_{sig} 118 of FIG. 1) which creates a set of time-stamped touch events 312 following the bit sequence being transmitted (e.g., input 308). As noted above other modulation techniques may be used in addition to or alternative to OOK modulation. For example, frequency modulation could be used by altering the frequency of the signal to communication information.

Since the events generated follow the bit sequence being transmitted, these events can be used to reconstruct the original bit sequence, which is unknown to the screen otherwise. Thus, in this setting, the channel can be thought of as the combination of all hardware and software components that affect the relationship between the transmitted bit sequence and the events registered including the series of capacitances (e.g., C_{B} 112, C_{c} 114, and Cₛ 110), the firmware that comes with the screen, and the proprietary driver that is a part of the device's operating system.

Unfortunately, due to the internal switching frequency inside the touch panel, non-deterministic amount of charge accumulation, and firmware/driver artifacts, the number and the timing of the events do not directly follow the input sequence. For example, as shown in FIG. 3, when the first bit (“BIT1”) is transmitted, three touch events are triggered, while five events are generated for a third bit (“BIT3”) and four events are generated by a fourth bit (“BIT4”). Furthermore, even though transmission of a zero should not trigger touch events, one event is generated for a second bit (“BIT2”) and two events are generated in a fifth bit (“BIT5”), even though the Tx signal 310 is off. In addition, the channel 306 adds a variable and unknown delay between the transmitted sequence and the touch event registered.

The Tx signal 310 transmitted by the ring generates touch events represented by the 6-tuple structure depicted in FIG. 4. Because the only information used are the timestamps (Timestamp field) of the events registered by the screen driver, the system requires an unconventional receiver design. Instead of the usual practice of looking at the amplitude (TouchAmplitude field) of the received signal, which in this case is not related to the transmitted data, the number of events registered are used for demodulating. That is, the software component receives a one bit if the number of events which appeared in that bit period is greater than a certain threshold and receives a zero bit otherwise.

As mentioned above, there is a variable delay from the moment the touch events are registered to the kernel until it is handed to the application-level software, e.g. an application-level demodulator. This delay makes demodulating less accurate. The time variance, we suspect, is due to the queuing and processing delays incurred when the event information travels up the software stack, from the touch-event handler in the kernel to the application level. To mitigate this inaccuracy, a demodulator may look at the touch event timestamps at the kernel level.

A key challenge is to handle the variance in the number and timing of the events that is introduced by the channel 306. To address this issue, the expected behavior of the channel 306 is characterized, reflected in terms of event counts, for decoding of the received sequence. Specifically, a joint decoding-synchronization technique is applied that uses a threshold-based and distance-based method to simultaneously synchronize and decode the received sequence.

In scenarios where the transmitter 302 is a ring, the ring can communicate with the touch screen device as long as the ring bearing finger is in contact with the screen. In particular, the electrical pulses that are transmitted from the ring through a human finger's skin create the same effect of changing the screen capacitance to register artificial touch events. This capability of the communication system can be leveraged to enable a novel technique to differentiate two users simultaneously interacting with the same touch screen, e.g., in a shared-screen two player game. The detection algorithm used for this mode of communication is described in further detail below.

The proposed capacitive touch communication system allows users to send messages to the application layer of the device. This unconventional use of the touch screen, especially under the constraint of using commercial off-the-shelf devices without lower layer access, poses a number of challenges. These challenges will now be addressed separately below.

First, the receiver 304 may respond differently to the same input following a different bit pattern. This may be due either to the physical layer or the software that is optimized for detecting touch events from a human finger. For example, the number of events registered to the screen when a one bit is sent after along sequence of zero bits is different from that of a one bit that follows a sequence of one bits. In some scenarios, the data is coded to avoid this pattern dependent effect. Rather than adopting a typical bit-by-bit decoding solution, the data rate is already so limited that a special code may be optimized specifically for the observed pattern dependence.

Second, there is a variable delay between the transmission of a symbol and its reception at the receiver 304 after processing through all layers of firmware and software. This jitter significantly increases the difficulty of detection. Since the communication channel has low bandwidth and high jitter, no traditional symbol synchronization schemes can be directly applied. This bit synchronization challenge may be overcome by simultaneously synchronizing and demodulating the signal.

Third, the channel 306 adds an unknown delay between receiver 304 and transmitter 302. This problem can be solved using a frame synchronization which requires using a preamble. Because of the relatively low bandwidth channel 306 and limited time to transmit, the message may only include a limited number of bits. Thus, a preamble may be undesirable in some scenarios. Instead, constrained bit patterns may be used that are unique under cyclic shifts caused by unsynchronized frames.

The conversion from touch events to a sequence of binary digits is based on the principle of signal modulation, such as an On-Off keying based signal modulation technique. In the On-Off keying scenarios, the touch screen driver produces several events when a binary one is transmitted and only a few events when a zero is transmitted. The key challenge is to handle the variance in the number of events associated with ones and zeros. An off-line calibration procedure to characterize the expected behavior of the channel may be used in the online phase to classify touch responses as zero bit or one bit transmissions. Once a sequence of bits is decoded, a “closeness” metric is used to determine the distance of the received message from the set of all possible messages of the same length. This process corrects for uncertainty in timing and event number. Details about the design of the closeness metric and the decoding process are described below.

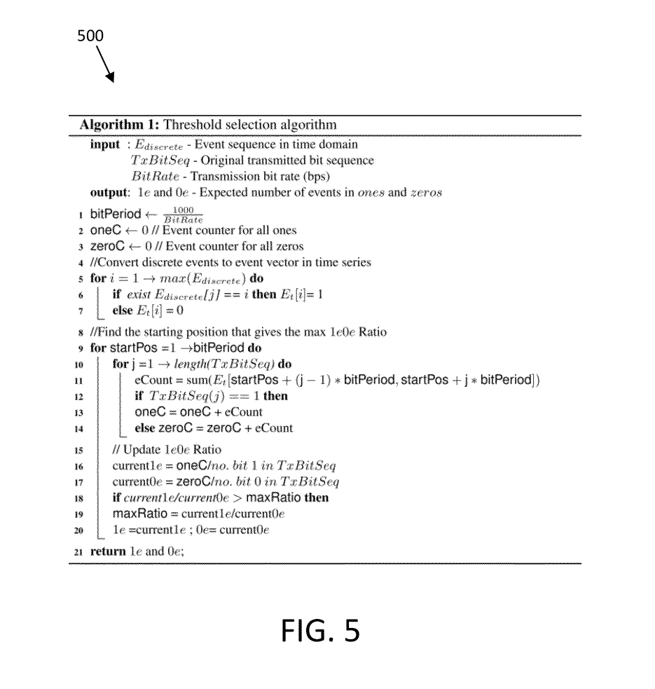

To determine the number of touch events associated with a one or zero, it is necessary to calibrate the device at each data rate before use. This calibration to determine thresholds can be performed only once per device, for example at the time off an initialization of the device. Thereafter, the thresholds can be stored in a lookup table and/or adjusted during self calibration depending on an estimate of the data rate of the incoming data sequence or fetched as an input from applications. To determine the counting threshold for each data rate, a sequence of ones and zeros is repeatedly transmitted in a prescribed pattern. On the receiver side, event sequence is detected and recorded to a log file. In some scenarios, a threshold selection algorithm takes the log file and the prescribed pattern as input to compute the two expected counter thresholds 1e (the number of events registered in a one bit) and 0e (the number of events registered in a zero bit). An example of an algorithm 500 for this purpose is shown in FIG. 5. Algorithm 500 simultaneously demodulates the received event sequence and finds the bit starting point. The intuition behind algorithm 500 is that the correct bit synchronization maximizes total number of events in all ones and minimize number of events in all zeros. The 1e0e ratio is defined as being the normalized ratio between the total number of events in all ones and total number of events in all zeros, as shown by the following mathematical equation (1).

$$1 e 0 e Ratio = \frac{\frac{Σ ( Event Counters in Ones )}{Number of Ones}}{\frac{Σ ( Event Counters in Zeros )}{Number of Zeros}} \qquad ( 1 )$$

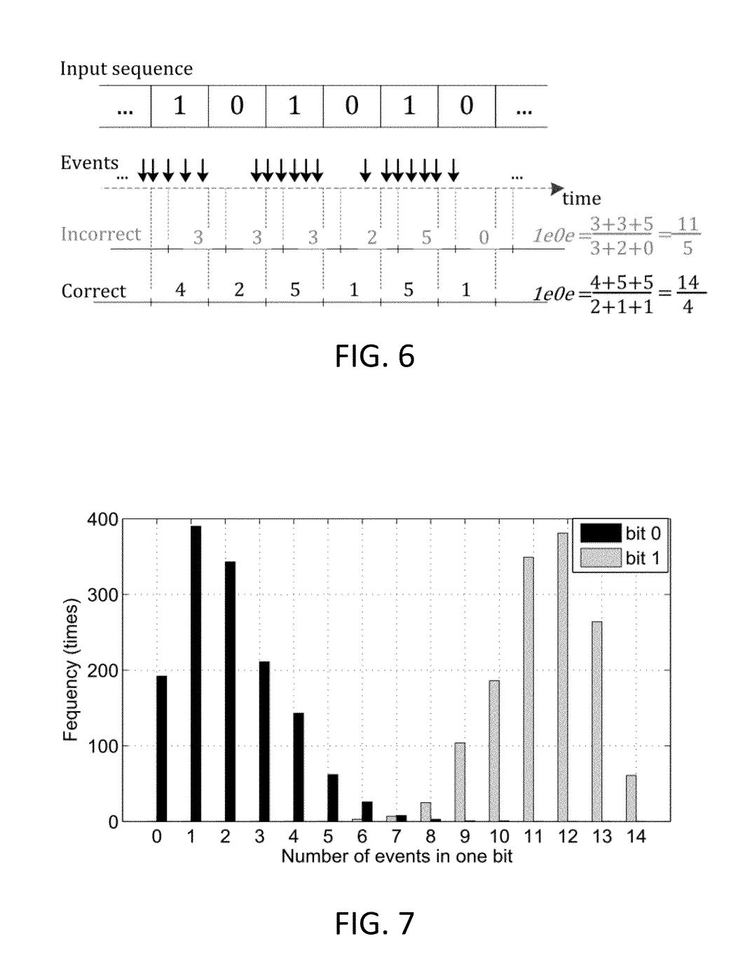

In some scenarios, the 1e0e ratio is maximized when bit synchronization is correct. The ideal synchronization, for example, should have a total number of events in all zeros close to 0, and a number of events in all ones close to the total number of events in the whole event sequence, in which case 1e0e ratio reaches its maximum. Illustrated in FIG. 6, in which the transmitter repeatedly transmits a sequence of alternating zeros and ones, the incorrect synchronization misaligns many events of bit ones into bit zeros making the 1 e0e lower compared to that of the correct synchronization. Algorithm 500 first converts the discrete timing event information to a event/no-event time series data. That is, if the received sequence of event is E_{discrete}={E₁, E₂, . . . , Eₘ} in which Eᵢ is i^{th} event, it will be represented by a vector in the form: Et=[Et₁, Et₂, . . . Etₜₘₐₓ] where Etᵢ=1 if there exists an event Eₖ such that Eₖ=i, and 0 otherwise. In the second step, the algorithm 500 tries all possible bit starting points within the first bit period, with each trial involving a counting of the number of events in all bit periods of the sequence. The starting point that leads to the highest ratio is considered the correct bit sync position, while the bit sequence corresponding to that starting point is the demodulated result of the event sequence. At the end of this process, since the total number of events in all ones and total number of events in all zeros is found, the expected number of events in ones and zeros, 1e and 0e, can be derived and stored in memory for future demodulation. FIG. 7 shows an example distribution of the number of touch events registered corresponding to the transmissions of zero for a 3000 bit sequence of alternating zeros and ones. The variations due to the transmission bit rate are recorded in the following Table 1, which shows that the event count threshold required for decoding varies from 7 events for 4 bits/s to 2 events for 15 bits/s.

TABLE 1

| Bit Rate (bps) | 4 | 5 | 8 | 10 | 12 | 15 |
|---|---|---|---|---|---|---|
| Expected no. of | 11.3 | 9.2 | 5.8 | 4.5 | 3.6 | 3.3 |
| events in ones (1e) | | | | | | |
| Expected no. of | 2.0 | 1.6 | 1.2 | 1.0 | 0.7 | 0.7 |
| event in zeros (0e) | | | | | | |
| One-Zero threshold | 7 | 6 | 4 | 4 | 2 | 2 |

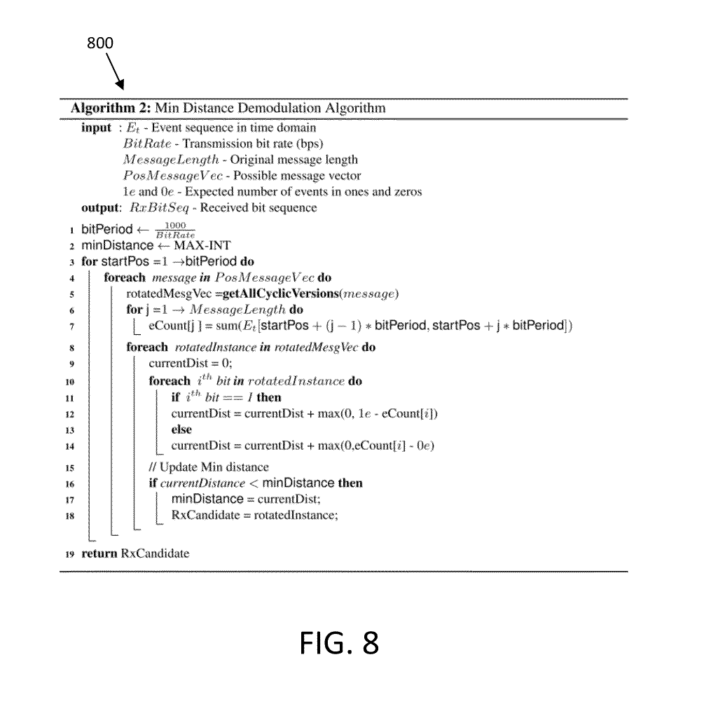

Using the counter thresholds determined using algorithm 500, algorithm 800 shown in FIG. 8 demodulates the timing event sequence to get the data sequence sent by the transmitter. Sharing the same synchronization challenge with a threshold detection algorithm, algorithm 800 has to detect the point in time at which the data is transmitted. At the same time, algorithm 800 demodulates the event sequence to decode the information that has been transmitted. Note that simply relying on the first event to determine the starting point is not enough since there is a fair amount of timing uncertainty in the communication channel. Intuitively, algorithm 800 traverses the sequence to try all possible starting points. At each point, it gauges the “distance” between the event sequence and all messages. It then ranks the positions with “similarity” value and selects the one that has highest “similarity” index. The message corresponding to that index will be the decoded value of the event sequence.

So the question remains as to how to measure the similarity between two sequences. A distance metric is defined as follows. Let D(i,j) be the distance between an event sequence that has a starting point at point i and the message, Kⱼ, with j=1 . . . number-of-messages. Using the same notations as defined in algorithm 500, in which Et=[Et₁, Et₂, . . . , Etₜₘₐₓ] is the event vector re-sampled along the time domain, an event counter, eCₚ, for bit at p^{th} position from the starting point can be computed as shown in the following mathematical equation (2).:

$${eC}_{p} = {\sum }_{q = ( p - 1 ) * bit period}^{p * bit period} {Et}_{q} \qquad ( 2 )$$

Then distance D(i,j) can be derived as shown by the following mathematical equations (3) and (4).

$$\begin{matrix}D ( i , j ) = {\sum }_{k = 1}^{message length} {d}_{k} \\ With & ( 3 ) \\ {d}_{k} = \{ \begin{matrix}max ( 0 , {eC}_{p} - 0 e ) , if the {k}^{th} bit on message {K}_{j} is 0 \\ max ( 0 , 1 e - {eC}_{p} ) , if the {k}^{th} bit on message {K}_{j} is 1\end{matrix} \} . & ( 4 )\end{matrix}$$

Since messages are cyclically transmitted, algorithm 800 does not only compute the distance of a sequence to a message but it does so for all unique rotated versions of that message.

The intuition behind this metric is that it rewards starting points that make the decoded sequence look similar to one of the messages in the message vector. The smaller the distance, the closer the decoded sequence to the message. Hence, the smallest D(i,j) will tell which position on the sequence is the correct synchronization position and which message is represented by the event sequence.

One of skill in the art will note that when the number of possible messages is small (order of hundreds), it is feasible to apply algorithm 800 to exhaustively search through the whole message space to demodulate. However, when the number of possible messages is large, the above exhaustive algorithm can become prohibitively expensive or impossible. In such cases, a more efficient algorithm assuming no knowledge of the message becomes handy. That algorithm shares the same intuition with algorithm 800, in that it tries all possible starting points. However, at each possible position, it directly converts the sequence to data bit sequence by counting number of events in each bit period and select the one that yields the highest 1e0e ratio.

Other demodulation schemes may be used such as Non-thresholding modulation, 1e0e ratio demodulation, and maximum key correlation. A non-thresholding modulation scheme does not require any training to learn expected number of events in zeros and ones. The non-thresholding modulation scheme instead looks at all possible starting positions and compares them with all possible keys to find the best match. The comparison is done by counting the number of touch events in one bits and zero bits. The ratio between the two counters is used as the correlation metric. Non-thresholding modulation simultaneously picks the synchronization point and decodes the sequence of events by selecting the starting point that gives the highest correlation with one of the possible keys.

The maximum key correlation method takes an approach that is similar to the minimum distance modulation but has a different evaluation function. Another correlation coefficient function is defined to take the noisy channel into account. Specifically, the function gives one point to a bit that is equal to the bit at the same position on the correct key and gives partial point to the bit that is not correctly decoded but has a number of events close to the one-zero threshold.

Lastly, by relaxing the requirement about the prior knowledge of the possible message space, a third alternative demodulation method becomes useful, 1e0e ratio demodulation. It becomes useful when the possible message space is unknown or so large that it is prohibitively expensive to conduct an exhaustive search to find minimum distance or maximum correlation. All three alternative algorithms however do not perform as well as the minimum distance presented above.

As mentioned above, an indirect mode of communication is enabled when instead of a ring, a ring bearing finger is in direct contact with the touch-screen. In such cases, only the presence of a ring needs to be detected. However detecting the ring in the presence of finger movements (or finger swipes) is challenging since the events generated due to the movement of the finger and those by the ring cannot be easily distinguished.

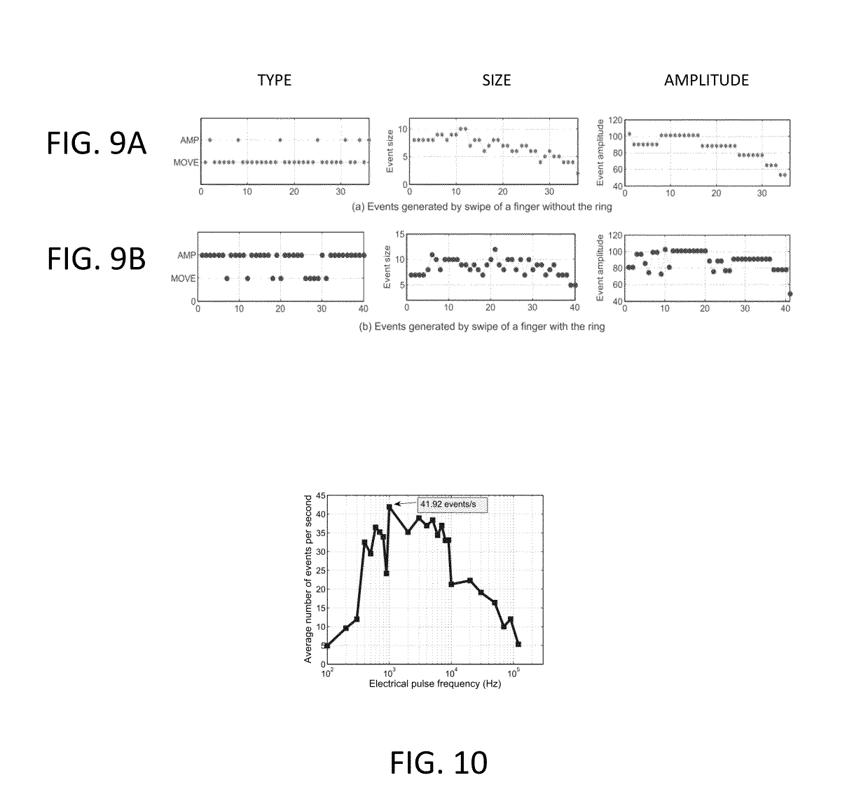

Referring to FIGS. 9A-9B graphs are provided that illustrate three fields of the touch event outputs. These fields are type, size and amplitude and are generated when a user swipes a finger across the screen with (FIG. 9A) and without (FIG. 9B) the ring. A robust detection algorithm can be designed by levering two key observations. First, events generated by the finger movement without the ring are mostly of type MOVE while those generated by the ring are mostly of type AMP. However, due to the excess pressure exerted from the drag force of the finger on the touch-screen, a few AMP events can also be generated during finger swipe movements without the ring. Secondly, in the absence of the ring, the sequence of Size and Amplitude values are correlated since increasing the pressure brings more surface area of the finger in contact with the screen. Both of these effects can be seen in FIGS. 9A-9B.

Since both the presence of a large number of AMP events and the absence of correlation between Size and Amplitude indicate the presence of a ring, a metric p_{ring}, which relates to the normalized number of AMP events registered (nₐₘₚ) and the correlation coefficient between the Size and Amplitude values (c_{SA}) as:

p_{ring}=α×nₐₘₚ(1−α)×(1−c_{SA}) (5)

where α∈[0,1] is a parameter which signifies the relative contributions of nₐₘₚ and c_{SA} in determining the p_{ring} value. Given a set of generated events, a detection threshold λₜₕ is then used on the p_{ring} value to classify the presence or absence of the ring. In a scenario, the values of the two parameters α and λₜₕ are determined through a training set consisting of 1000 swipes from 3 different users, using traditional least square minimization. After the training, α and λₜₕ are determined to be 0.83 and 0.5 respectively.

As mentioned above, typically, the inner-workings of the touch screen are proprietary and not available for use in designing either the hardware or software for capacitive touch-screen communication. A main task is to determine what type of electrical signal will be interpreted as a touch event when it is injected into the touch-screen. In some scenarios, different signals from a function generator can be inserted through an attached electrode approximately the size of a finger to the surface of the touch-screen. The goal is to reliably create artificial touch events while also creating those event at maximum rate. Since the transmitter modulates the signal using an OOK scheme in some scenarios, a higher event rate can result in faster transmission.

In some scenarios, touch events retrieved by the operating system are represented in a 6-tuple structure depicted in FIG. 4 bnIndicated through Event Type field, touches are classified into one of the following types: MOVE, AMP, MOVEAMP, PRESS, RELEASE and SUPPRESS. For example, a MOVEAMP event is registered when both touch pressure and (X,Y) coordinates change at the same time. A SUPPRESS event happens when the touch pressure exceeds a predefined threshold. Note that touch events are triggered when a finger first touches the panel, when the position of the finger on the screen changes, when the pressure changes, and/or when the finger leaves the screen. Touch Size and Touch Amplitude specify the size and amplitude of the touch respectively. Pointer ID is used to differentiate the presence of two or more points of contact at the same time, or multi-touch. A physical touch causes voltage changes at many different electrodes, but the firmware and driver aggregate them to output a single touch event to the operating system. Since the driver and firmware is likely proprietary, the conversion from electrical signals of interest to such touch events can be learned empirically.

An important aspect of the system is the maximum possible data rate through the screen, which depends on two key characteristics of the screen: the highest rate at which the driver and firmware allows touch events to be registered and the internal switching frequency of the sensing hardware. One commercially available touch-screen controller specifies a maximum of 150 raw touch events per second. However, due to the driver of the operating system software stack, the maximum rate is significantly reduced. Experimental results can be used to gauge the actual maximum event detection rate. Signals transmitting with different wave forms and at different frequencies and voltage levels can be sent to a screen. In some scenarios, as shown in FIG. 10, with frequencies ranging from 100 Hz to 120 KHz, a 10 volt peak-to-peak square wave signal at a frequency of 1 KHz can register the maximum rate of 41 events/second (i.e. average inter event arrival time of 1/41 seconds=24 ms).

In some scenarios, to find the frequency to which the touch-screen was most responsive, a digital function generator generates square waves of different frequencies at a 10 volt peak-to-peak amplitude. The frequency was varied from 100 Hz to 1 KHz in 100 Hz increments, from 1 KHz to 10 KHz in 1 KHz increments, and from 10 KHz to 120 KHz in 10 s KHz increments. To collect the signals, the output from the function generator is wired to a flat soldered electrode. The electrode is then placed on the surface of a tablet touch-screen. To make the electrode stable on the surface, the electrode may be attached, e.g. via tape, to the touch-screen to avoid unintended movement. For each frequency, data was collected for 200 seconds. Then, the number of events was collected from the kernel. The average number of events is shown in FIG. 10, which suggests that the screen best responds to a signal at 1 KHz.

While almost 90% of the times, 2 consecutive events captured by the kernel log happen within 20 ms with very little variation, that number widely varies from 3 ms to 48 ms in the case of the application level log. That observation indicates that using the timing information from kernel level log could improve the demodulation results which mainly relies on event timestamps.

Most of the inter-arrival times fall into specific narrow bands which may be due to firmware throttling. Its cumulative distribution shows that 98% of the time, the inter-event arrival time is less than 40 ms. Note that this event detection rate is more than 7 time slower than the rate of 150 raw touch events per second specified above. Without access to the physical layer and the proprietary driver, we cannot determine the origin of this discrepancy. The data rate could be at least 7 times faster than what was described above with access to the driver; and even higher data rates might be possible with direct access to the lower physical layer.

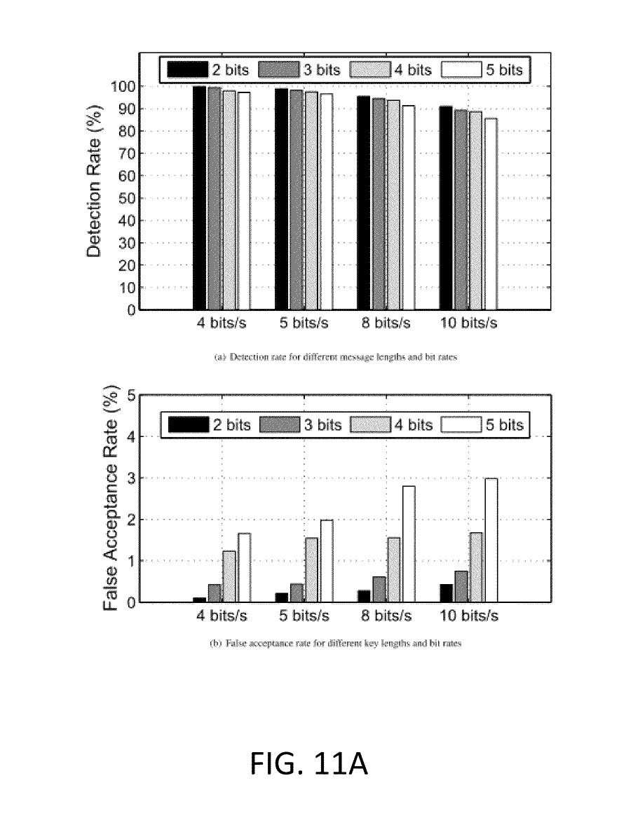

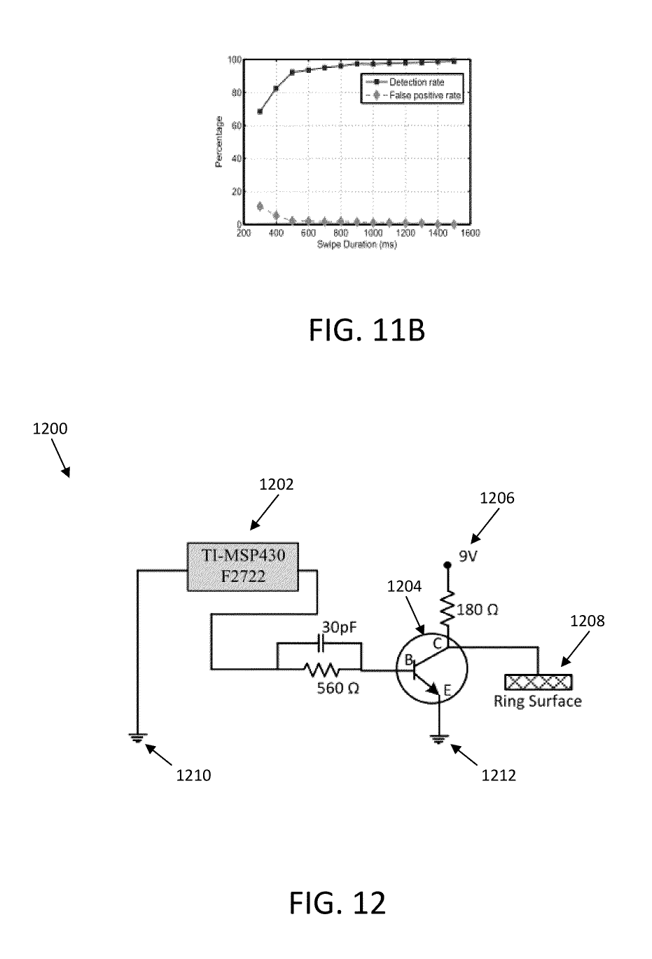

The main performance metrics here are the detection rate and the false acceptance rate. The detection rate signifies the probability of correct decoding of a message while the false acceptance rate characterizes the probability of a wrong message being incorrectly decoded as the original message. As explained above, there exists a trade-off between the detection rate and the bit rate at which messages can be decoded from the touch screen event logs. Correspondingly, since there are higher chances of incorrect decoding at higher bit rates, the number of false positives increase as the bit rate increases. In order to quantify this phenomenon, messages of different lengths at different bit rates can be repeatedly transmitted. FIG. 11 shows the detection and false acceptance rates observed. To derive the detection rate for each message length and bit rate, each message of each length is transmitted 5000 times and present the average percentage of messages that are correctly decoded. Similarly, the false acceptance rate is derived by sequentially fixing each message as the correct message and transmitting all other messages of the same length 5000 times.

The trends in FIG. 11A indicate a gradual decline in the detection rate with the increase in either the transmission bit rate or message length. It should be noted that for simple parental control applications, a 99% detection rate can be achieved by using 2 or 3-bit messages at 4 bits/s. For applications that have a less stringent detection rate requirement, a much higher bit rate can be used to speed up the required data transmission time. For authentication applications, transmitters typically need to transmit a longer bit sequence. To get the similar entropy level that the 4-number PIN code has, for example, transmitters have to send a 14-bit long sequence into the screen, which could take about 3 seconds at 5 bits/s.

The next set of results are targeted towards detection of individual users in an indirect communication scenario. In this scenario, while the bit rate required is not very high, touching the ring to the touch screen would hinder in the game-playing process. Even if the finger-tip of the ring bearing finger touches the screen, the patterns in the registered event logs can be used to differentiate between a user with a signet ring and the one without it.

To quantify the performance of this algorithm, a total of 6,000 swipes from 3 different users with half the swipes with a ring on. Users may vary the swipe duration between 300 ms to 1.5 seconds but since making a swipe last for precisely a given time is difficult, the collected swipes were bucketed into 100 ms durations starting from 250 ms to 1550 ms and discard swipes outside of this range. The swipe duration of all swipes within a bin are approximated by the mean value of the bin. Using the move events registered in this dataset, the detection rate of ring bearing users was calculates, as well as the percentage of swipes without rings which were wrongly classified as one with rings, i.e., the false acceptance rate.

The resulting values shown in FIG. 11B shows that the detection rate increases with the duration of the swipe, at first sharply from 68% for 300 ms swipes to 92% for 500 ms swipes and then gradually after that. Thus, if the duration of the swipes used in a multi-player game is longer than 700 ms, the users can be classified correctly with a 95% confidence level.

The use of the ring and this communication technique in general has minimal impact on the screen's operational performance (i.e. power consumption, touch event parameters) and to the running applications. Because it generates multiple touch events which are handled by the screen's firmware and the operating system, the ring introduces a small processing overhead to the mobile device. That overhead however is negligible compared to the legacy load of the mobile device. On the other hand, the effects of the ring on touch events' amplitude and size is observable.

Referring to FIG. 12, a schematic is provided of an example hardware token 1200. The core of the token is a low cost, low power microprocessor 1202, grounded at 1210. In some scenarios, the microprocessor is a TI-MSP430F2722 programmed to generate a modulated 3-Volt square waves at a frequency of 1 KHz. This square wave is modulated in accordance with a signal modulation technique to trigger artificial touch events in the screen's firmware. Signal modulation technique can include, but is not limited to, an amplitude modulation technique, a voltage modulation technique, a frequency modulation technique, or a combination two or more of the listed modulation techniques. In some scenarios, amplitude shift keying (e.g., an OOK) modulation technique is used. The transmission data rate and data sequence is specified by programming the microprocessor through the USB interface (not shown). In the OOK modulation scenarios, the square wave and its parameters may be selected through experiments with a function generator, as described in above. The 3-volt signal may be amplified out of the microprocessor using a single bipolar transistor 1204 (grounded at 1212), with the supply voltage 1206 of 9 Volts. The signal, e.g, V′_{sig} 118 of FIG. 1, output to the finger and the rest of the body through the ring surface 1208 at a point close to the screen. In some scenarios, the user would wear an insulating ring where V′_{sig} was injected between electrodes on the inside and outside of the dielectric band. The inner electrode may be connected with the finger and, through the body capacitance C_{B} and case capacitance C_{c} (as described above in reference to FIGS. 1 and 2), to the internal circuitry in the tablet. The outer electrode on the ring is directly pressed on the screen, forming Cₛ to complete the circuit.

Because a uniform and reproducible contact between the touch screen and the ring is essential to minimize the error rate, a flexible conductive material may be used to make the electrode and design the face of the ring to control the compression of that material. If the pressure is too high, the screen bends and its capacitance, Cₛ, increases which in turn can introduce errors. This pressure can be controlled by surrounding the electrode with an insulating spacer of the correct thickness to properly control the compression of the flexible electrode.

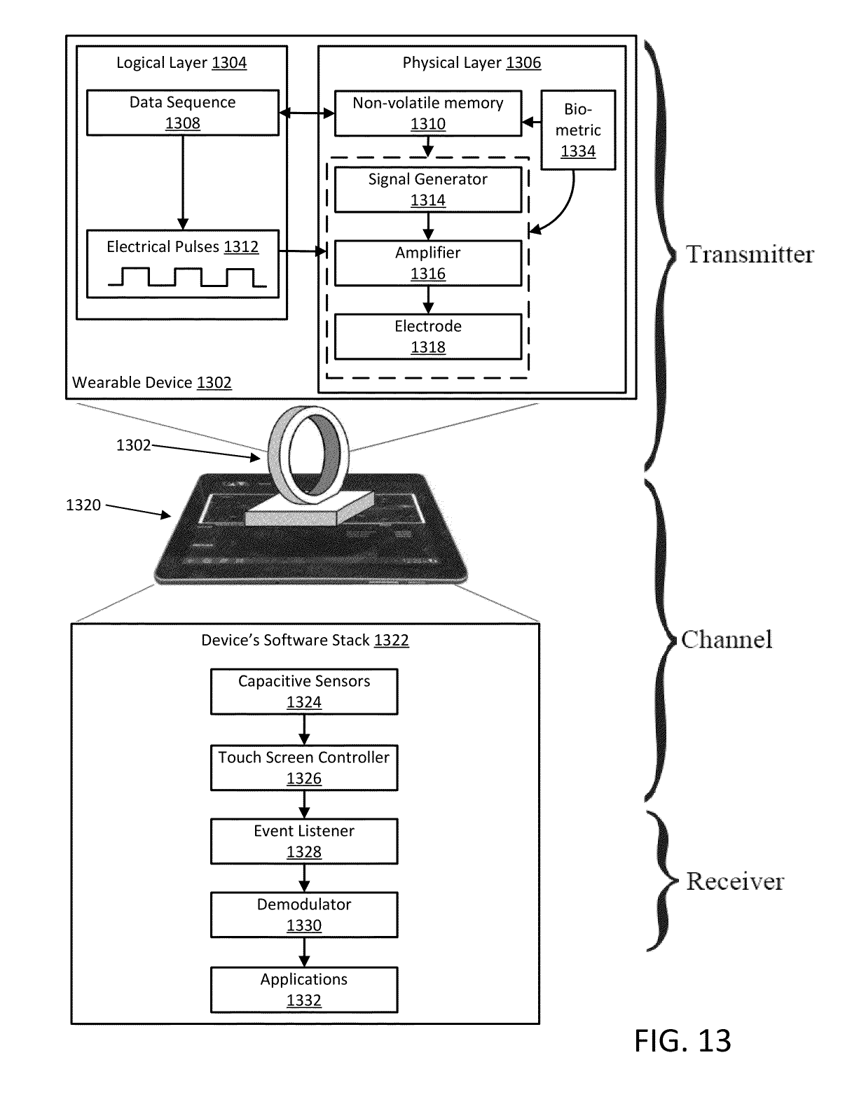

Referring to FIG. 13, a block diagram is provided of an example device 1302. In some scenarios, the device 1302 is a wearable device in the shape of a ring. The device 1302 includes a logical layer 1304 and a physical layer 1306. The physical layer represents the physical hardware of the device and includes non-volatile memory 1310, signal generator 1314, amplifier 1316, and electrode 1318. The logical layer represents the logical functions of the device. The data sequence 1308, stored in non-volatile memory 1310, is used to generate a series of electrical pulses 1312 representing the data sequence. The electrical pulses are then run through the signal generator 1314 to generate a modulated signal which is then amplified by amplifier 1316 before being output to electrode 1318.

As explained above, two or more electrodes may be present on the wearable device 1302 depending on the application for which the device 1302 is being used. For direct communication with capacitive touch-screen electronic device 1320, the electrode 1318 may be in direct contact with the capacitive screen of the device 1320. In the case of indirect communication, the electrode 1318 is in contact with the user's skin, e.g., the skin of the finger the ring is on.

As a security feature, bio-metric sensor 1334 may be included with the wearable device. Bio-metric sensor 1334 can detect unique signatures of a users body, such as characteristic resistance, impedance, and/or capacitance of the user. Other bio-metric signals may be used as well and scenarios are not limited in this regard. In a scenario, bio-metric sensor 1334 will only function when it detects the proper bio-metric signature. Wearable device 1302 may store the user's biometric signature in non-volatile memory 1310, either at initialization or during a reset of the wearable device. Information sufficient for describing and identifying the signature during future uses may be sensed during this initialization or reset phase. In another scenario, the information from the bio-metric sensor may be used to generate the data sequence 1308 that is transmitted through the capacitive touch screen of the electronic device 1320. Additionally, when an improper attempt is made to use the ring, the non-volatile memory 1310 may be erased, requiring a reset. One of skill in the art will recognize a variety of security techniques that can accomplished the described scenarios.

The electronic device 1320 includes a software stack 1322 that senses and interprets inputs from the capacitive touch-screen. Software stack 1322 may be implemented in firmware. For clarity, the physical components of electronic device 1320 are not included, however, one of skill in the art will recognize that a number of well known physical components within electronic device 1320 implement the software functions described in FIG. 13. The software stack 1322 includes capacitive sensors 1324 which directly sense changes in the capacitance of the screen and generate differences in voltage that are output to the touch-screen controller 1326 for processing. The touch-screen controller 1326 interprets the voltage differences from the sensors and categorizes the touch events, e.g. as described above into types MOVE, AMP, MOVEAMP, PRESS, RELEASE and SUPPRESS. The touch events are then output from the controller to the event listener 1328 at the kernel level. The event listener generates a time-stamp and other attributes of the touch event and produces information using the 6-tuple structure depicted in FIG. 4. With this information, the demodulator 1330 decodes the data into the original data sequence 1308. The decoded data is then given to an application which uses the sequence in accordance with it's functionality. For example, a parental control application may be used to unlock a device or an application restricted from use by children. Alternatively, the data sequence may be used as an authenticator for an ATM transaction. When used for indirect communication with electronic device 1320, the data sequence may be used by a game to differentiate between two players in a multiplayer game using the same screen. The disclosed scenarios are not limited in this regard.

In the transmitter/channel/receiver model described above, the device 1302 may be considered as the transmitter. The channel may include the capacitive screen of the electronic device 1320, the capacitive sensors 1324, and the touch screen controller 1326. The receiver may include the higher level event listener 1328, the demodulator 1330, and the applications 1332.

An application can be implemented that mimics common login authentication procedures. The application decodes a key carried by and transmitted from the ring. Depending on which key it receives, the application will load the profile of the corresponding user associated with that key. In one experiment, a first user carries a ring with the key ‘1110’ and a second user carries ring with the key ‘1000.’ Each user's ring contacted the tablet's display 50 times. A threshold-based algorithm that uses the number of touch screen events generated as input is able to identify the first ring correctly 44 times and the second ring 43 times, leading to an overall detection rate of 87%. The quality of the contact between the ring and the touch panel may play a role in the detection rate.

To eliminate the variance due to contact differences from touch to touch, another experiment included transmitting multiple messages while the ring was held steady on the display. Message lengths are between 2 and 5 bits transmitted at rates of 4 bits/s and 5 bits/s from which the Detection Rate (“DR”) and False Acceptance Rate (“FAR”) are evaluated. For each message at each data rate, the ring is placed onto the screen three times and kept there long enough so that 200 repetitions of the message are transmitted from the ring to the screen. The detection rate decreases with the increase of both the message length and bit rate. Note, however, that the overall detection rate may be improved through retransmissions of the message. Therefore, even a lower detection rate may still be adequate for some of our targeted applications. For the user identification application, for example, up to three seconds of continuous repeated message transmission results in less than 6 errors per 1000 uses. These results illustrate what can be achieved with this transmitter if the reliability issues are worked out.

Another potential source of error in this prototype stems from the relatively long rise time of the square wave since the touch screen events appear to be triggered by the edges in the input signal. It is also important to note that both the electronics and the firmware of the screen are optimized for the relatively slow movement of a human finger. Thus, the screen driver deliberately throttles the maximum rate of touch events to reduce touch error in normal use. This limits the disclosed system to a relatively low bit rate transmission. The transmission rate could be improved substantially with access to the touch screen controller firmware, to allow processing of internal touch screen measurements, e.g. physical voltage differences.

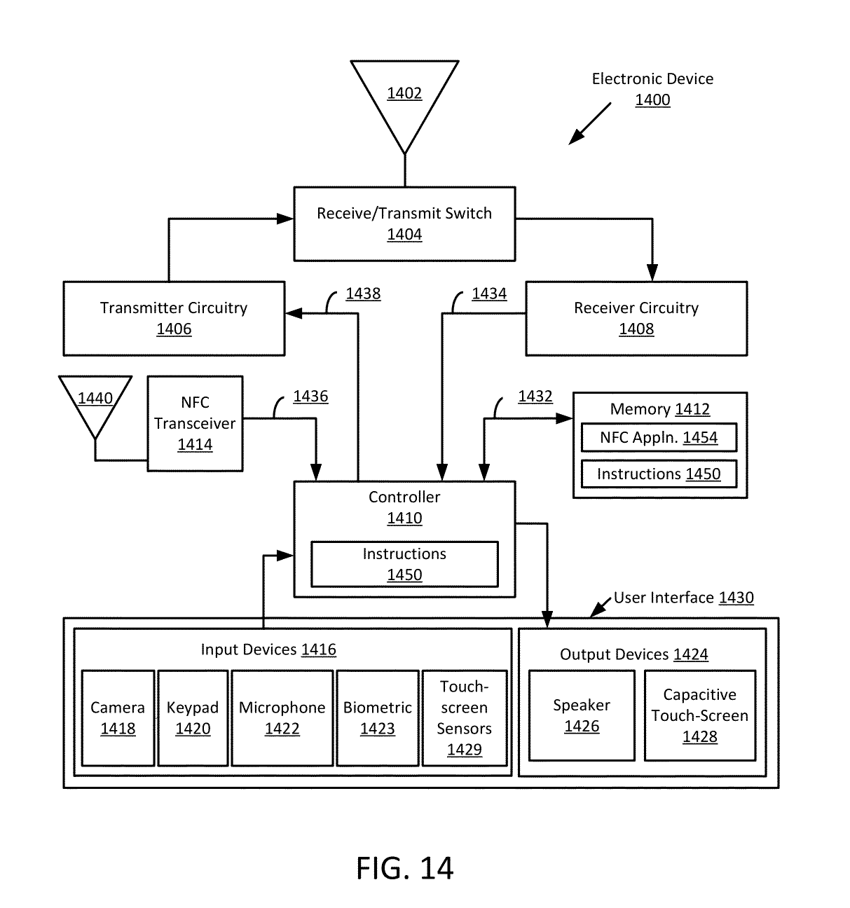

Referring now to FIG. 14, there is provided a block diagram of an exemplary electronic device 1400. An electronic device 1400 can include, but is not limited to, a notebook computer, a personal digital assistant, a cellular phone, or a mobile phone with smart device functionality (e.g., a Smartphone). Electronic device 1400 may include more or less components than those shown in FIG. 14. However, the components shown are sufficient to disclose an illustrative embodiment implementing the present invention. Some or all of the components of the electronic device 1400 can be implemented in hardware, software and/or a combination of hardware and software. The hardware includes, but is not limited to, one or more electronic circuits.

The hardware architecture of FIG. 14 represents one embodiment of a representative electronic device 1400 configured to facilitate the data exchange between a wearable device, e.g. device 1302 of FIG. 13. In this regard, electronic device 1400 comprises a capacitive touch-screen 1428 connected to controller 1410. The capacitive touch-screen is capable of receiving inputs from a wearable device by sensing variations in screen capacitance. Controller 1410 interprets the variations in screen capacitance as touch events, as explained above. Other features of electronic device 1400 are described below.

Electronic device 1400 an antenna 1402 for receiving and transmitting RF signals. A receive/transmit (“Rx/Tx”) switch 1404 selectively couples the antenna 1402 to the transmitter circuitry 1406 and receiver circuitry 1408 in a manner familiar to those skilled in the art. The receiver circuitry 1408 demodulates and decodes the RF signals received from a network. The receiver circuitry 1408 is coupled to a controller (or microprocessor) 1410 via an electrical connection 1434. The receiver circuitry 1408 provides the decoded signal information to the controller 1410. The controller 1410 uses the decoded RF signal information in accordance with the function(s) of the electronic device 1400.

The controller 1410 also provides information to the transmitter circuitry 1406 for encoding and modulating information into RF signals. Accordingly, the controller 1410 is coupled to the transmitter circuitry 1406 via an electrical connection 1438. The transmitter circuitry 1406 communicates the RF signals to the antenna 1402 for transmission to an external device via the Rx/Tx switch 1404.

An antenna 1440 may be coupled to an NFC transceiver 1414 for receiving NFC signals. NFC transceivers are well known in the art, and therefore will not be described in detail herein. However, it should be understood that the NFC transceiver 1414 processes the NFC signals to extract information therefrom. The NFC transceiver 1414 may process the NFC signals in a manner defined by an NFC application 1454 installed on the electronic device 1400.

The controller 1410 may store received and extracted information in memory 1412 of the electronic device 1400. Accordingly, the memory 1412 is connected to and accessible by the controller 1410 through electrical connection 1432. The memory 1412 may be a volatile memory and/or a non-volatile memory. For example, the memory 1412 can include, but is not limited, a RAM, a DRAM, an SRAM, a ROM and a flash memory. The memory 1412 may also comprise unsecure memory and/or secure memory. The memory 1412 can be used to store various other types of information therein, such as authentication information, cryptographic information, location information and various service-related information.

As shown in FIG. 14, one or more sets of instructions 1450 are stored in memory 1412. The instructions 1450 may include customizable instructions and non-customizable instructions. The instructions 1450 can also reside, completely or at least partially, within the controller 1410 during execution thereof by electronic device 1400. In this regard, the memory 1412 and the controller 1410 can constitute machine-readable media. The term “machine-readable media”, as used here, refers to a single medium or multiple media that stores one or more sets of instructions 1450. The term “machine-readable media”, as used here, also refers to any medium that is capable of storing, encoding or carrying the set of instructions 1450 for execution by the electronic device 1400 and that causes the electronic device 1400 to perform one or more of the methodologies of the present disclosure.

The controller 1410 is also connected to a user interface 1430. The user interface 1430 comprises input devices 1416, output devices 1424 and software routines (not shown in FIG. 14) configured to allow a user to interact with and control software applications (e.g., application software 1452-1450 and other software applications) installed on the electronic device 1400. Such input and output devices may include, but are not limited to, a touch-screen display 1428, touch-screen sensors 1429; a speaker 1426, a keypad 1420, a directional pad (not shown in FIG. 14), a directional knob (not shown in FIG. 14), a microphone 1422 and a camera 1418. The display 1428 may be designed to accept touch screen inputs. Touch-screen display 1428 includes touch sensors 1429 that receive and transmit the sensed touches (i.e. variations in capacitance and/or voltage) to controller 1410, which interprets the capacitance and voltage differences for higher level processes, e.g. the kernel, operating system, and/or applications. Touch-screen display 1428 may be implemented using any touch screen technologies which are well known in the art. In a scenario, touch screen display 1428 is a capacitive touch-screen display. The operation of capacitive touch-screens is described above in reference to FIGS. 1 and 2. User interface 1430 can facilitate a user-software interaction for launching applications (e.g., application software 1452-1450) installed on electronic device 1400. The user interface 1430 can facilitate a user-software interactive session for writing data to and reading data from memory 1412. Further biometric sensor 1423 can support biometric security features.

The display 1428, keypad 1420, directional pad (not shown in FIG. 14) and directional knob (not shown in FIG. 14) can collectively provide a user with a means to initiate one or more software applications or functions of the electronic device 1400. The application software 1454-1450 can facilitate the data exchange between a wearable device (e.g., device 1302) and capacitive touch-screen 1428. In this regard, the application software 1454-1450 performs one or more of verifying an identity of a user of the electronic device 1400 via an authentication process and presenting information to the user indicating that her/his identity has been or has not been verified.

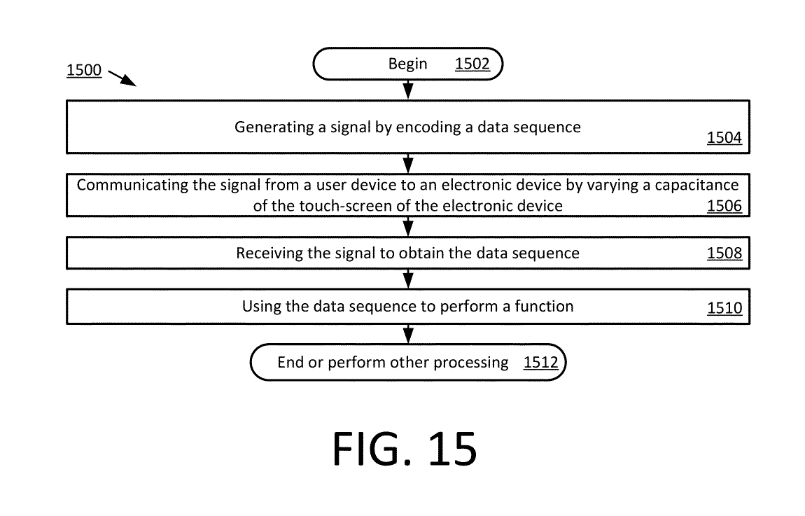

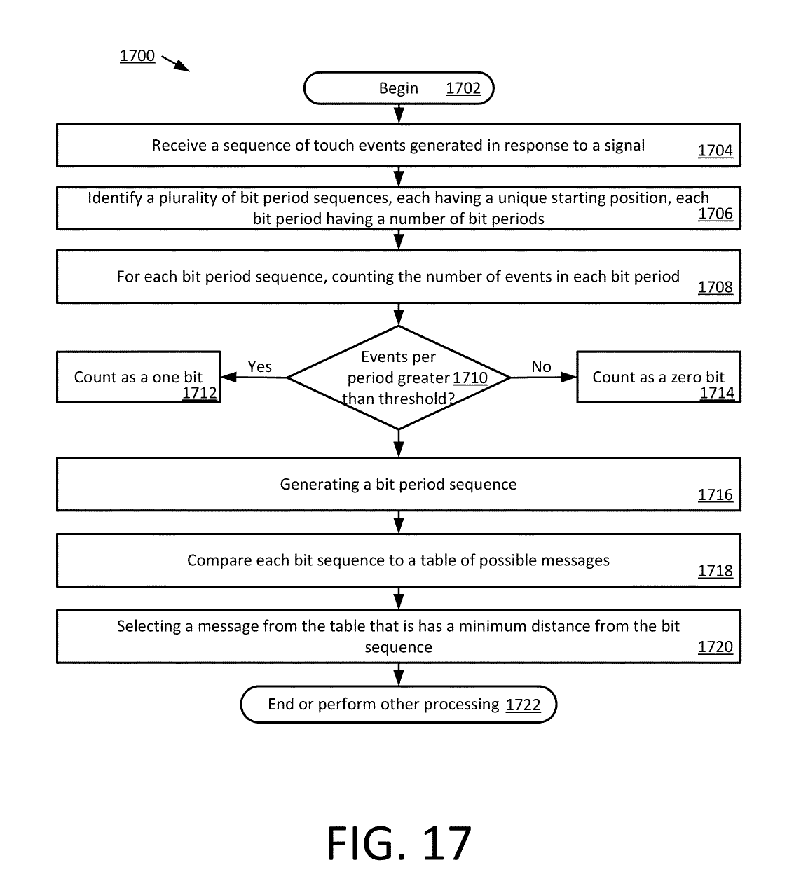

Referring now to FIG. 15, a flow chart is provided illustrating a process 1500. Process 1500 begins at step 1502 and continues to step 1504 where a signal is generated by a user device, e.g. device 1302 of FIG. 13. In a scenario, the signal is modulated using well known modulation techniques. The modulated signal may be generated by modulating a data sequence stored in a memory of the user device, for example. At step 1506, the signal is communicated from the device to an electronic device, e.g., electronic device 1400 of FIG. 14, by varying a capacitance of the touch-screen of the electronic device. The user device may communicate to the electronic device using the techniques described above. At step 1508, the signal is received and, if the signal is modulated, demodulated at the electronic device. The variations in capacitance may be detected by the capacitive sensors of the electronic device and interpreted by a capacitive touch screen controller as touch events. The demodulation process is described in greater detail below in reference to FIG. 17. After the signal has been received and decoded and/or demodulated, the electronic device obtains the data sequence that was stored in and communicated from the user device. At step 1510, the electronic device uses the data sequence to perform a function. For example, the electronic device may use the data sequence to authenticate the user of the user device. Alternatively, the electronic device may use the data sequence to differentiate the user of the user device from another user using the same touch screen but not using a user device and/or using a different user device. Other functions include parental control, ATM authorizations, and the like. The scenarios of the present invention are not limited in this regard. At step 1512, process 1500 ends or other processing is performed.

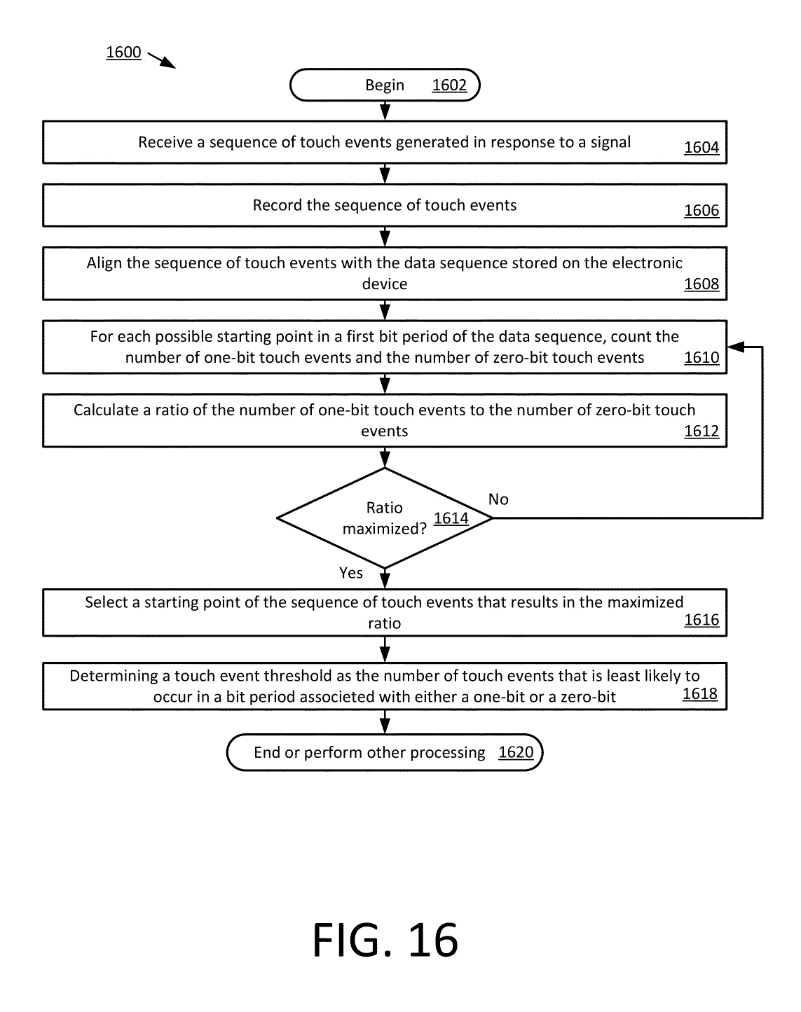

Referring now to FIG. 16, a flow chart is provided illustrating a process 1600 for training, by a user device, e.g. device 1302 in FIG. 13, an electronic device, e.g., electronic device 1400 of FIG. 14, through a capacitive touch screen of the electronic device. This training process only needs to occur once, the first time a user device is used to communicate with a particular touch-screen. Process 1600 begins at step 1602 and continues to step 1604 where an electronic device receives a sequence of touch events generated in response to a signal generated and transmitted by the user device. The process assumes that the electronic device already has knowledge of the correct bit sequence. For example, the bit sequence may be stored in the memory of the electronic device. At step 1606, the sequence of steps is recorded by the electronic device. In some scenarios, the signal may be a repeatedly transmitted data sequence. For example, the electronic device may record a time stamp for each touch event received for later analysis At step 1608, the sequence of touch events is aligned with a data sequence that is stored on the electronic device. In other words, the starting point of the bit sequence is determined. In step 1610, for each possible starting point in a first bit period of the data sequence, the number of touch events for each bit period is counted. Since the correct data sequence is known to the electronic device, the number of touch-events in each one-bit period and in each zero-bit period can be counted. The total number of touch events in all one-bit periods is divided by the total number of touch events in all zero-bit periods to calculate the ratio of one-bit touch events to zero-bit touch events in step 1612. These steps repeat until the ratio is maximized. In other words, each bit period sequence, each starting at a different starting point in the first bit period, is analyzed to calculate the ratio of one-bit touch events to zero-bit touch events. If the bit sequence is not maximized (1614: NO), additional bit sequences are analyzed. If the ratio is maximized (1614; YES), then all bit sequences have been analyzed. At step 1616, the bit sequence with the starting point that generates the maximum ratio of one-bit touch events to zero-bit touch events is selected. At step 1618, at touch event threshold is determined to be the number of touch events that is least likely to occur in a bit period associated with either a one-bit or a zero bit. For example, referring to Table 1 and FIG. 7, for a 4-bit/s transfer rate, seven (7) touch events are least likely to occur within a bit period. Therefore, 7 is selected as the threshold in this scenario. At step 1622, process 1600 ends or other processing is performed.

Referring now to FIG. 17, a flow chart is provided illustrating a process 1700 for demodulating a modulated signal by the electronic device. Process 1700 begins at step 1702 and continues to step 1704 where an electronic device receives a sequence of touch events generated in response to a signal generated and transmitted by the user device. At step 1706, the electronic device identifies a plurality of bit period sequences in the sequence of touch events, each bit period sequence having a unique starting position and a number of bit periods. At step 1708, for each bit period, the electronic device counts the number of touch events. The electronic device determines whether the number of touch events per bit period is greater than a threshold at step 1710. If the number of events in a particular bit period is greater than the threshold (1710: Yes), the bit period is determined to be a one bit at step 1712. On the other hand, if the number of touch events in a particular bit period is less than the threshold (1710: No), the bit period is determined to be a zero bit at step 1716. At step 1616, the sequence of touch events is converted into a bit sequence by combining the one-bits and zero-bits identified in steps 1710-1714. In step 1718, the each bit sequence is compared to a table of possible messages. A message is selected from the table that is has the minimum distance from the received bit sequence at step 1720. In scenario, the minimum distance is determined using algorithm 800 of FIG. 8. Alternatively, the method above can be repeated for the entire message to demodulate the sequence of touch events without prior knowledge of the possible universe of messages. In this alternative scenario, the starting position is selected by identifying the bit sequence that has the maximum ratio of one bit touch events and zero bit touch events. For example, if there are 14 total touch events in bit periods that were determined to be a one bit and 4 total touch events in bit periods that were determined to be a zero bit, the ratio will be 14/4. The bit sequence with the maximum such ratio is assumed to correspond with the correct sequence. At step 1722, process 1600 ends or other processing is performed.

Energy consumption and some synchronization issues may be significantly reduced by incorporating a switch under the contact surface that powers up the ring when pressed against the touch screen. The typical current drain in standby with RAM-retention of a modern microprocessor (e.g. the TI MSP430 family) is about 0.1 micro amps. Even with a small lithium battery, this should provide over 30 years of standby lifetime for the ring electronics. Once awake, the processor will use significantly more current, but the minimal computing requirements result in this being low. The smaller MSP-430 processors typically use about 220 micro amps at 1 MHz, so even if shifting out the short code takes 100 cycles of the CPU, a small battery will still provide enough energy for over 5000 uses.

Since the capacitances are very small, the current will also be low and a simple buck-boost dc-dc converter with one miniature inductor will be adequate to supply the 9-Volt signal. Assuming only a 10% charge conversion efficiency for the converter, this circuit still uses only about two nano-couloumbs per charge-discharge cycle. Modulating at 1 KHz and sending 10 bits/second, this allows the battery to supply over 50 million bits, far in excess of any of the other limits in the system. The cost of such a system will be dominated by the processor, several tens of cents, but in high volume that can be replaced by a simple sequence generator, either read-only or flash, for only a few cents.

The current limits on data rate only allow transmission of very short codes and thus allow only weak authentication at best. Improvements in data rate through modifications in the touch screen firmware could alleviate these limits, however. The low carrier frequency of our system, between 5-10 kHz, would then also offer additional protection against eavesdropping. Since antenna size should be proportional to the wavelength of the signal, transmission of this signal into the RF domain would require an antenna much larger than the size of the human body. While it cannot be ruled out that some signals can be received with customized resonant antennas, however, the level of effort required would be much higher than for picking up a typical RF signal, e.g., 2.4 GHz signal used in WiFi and Bluetooth. If such eavesdropping ever were an issue, it could also be addressed by transmitting a noise signal from the receiving device.

Another security consideration is the concern of unauthorized use of the hardware token. It however can be addressed by integrating bio-metric signature techniques with the token as described above. In such scenarios, the transmission capability of the wearable device is activated only when the token recognizes the owner's bio-signature. The bio-signature may be the user's particular resistance, impedance, or capacitance of the figure. Additionally, because the signal is sent at the bit level, the data sequence can be encrypted prior to transmission. The sequence itself can be changed by the user for added security. Such sequence changes can be enforced through enterprise policies, e.g. through the feedback channel described below. The current design could be enhanced with a feedback channel using a photo detector. The ring could receive information from the mobile device through this visual channel, e.g. through a photo electrode on the ring, where the device encodes the information in the pixel intensities. This would enable a challenge response protocol, which could greatly enhance the security of an authentication system. In addition to challenge response security enhancement, the photo detector could receive acknowledgement signals from the tablet to ensure the reliability of the transmission. One way to use this feedback information would be for the signet ring to optimize detection by the tablet by varying the frequency and phase of the electrical pulse pattern.

An alternative physical layer approach could be to vary the effective capacitance between the ring and screen. This could be done by inserting another capacitor between the ring surface and the screen whose area or thickness could be modulated. Done properly, this could generate touch events with even less power than the current hardware design. Using the form factor of the ring surface that creates multiple contact points with the screen taking advantage of the multi-touch capabilities could further improve the data rate for any of the physical layer technique we discussed.

Another approach would vary the capacitance of the ring by opening and closing a switch connected to the inner electrode, that is in contact with the skin, to modulate the capacitance of the ring between the capacitance of the ring and the capacitance of the right plus the body capacitance (C_{B}) of the user. By modulating the switch that connects the ring with the user, data can be transmitted through the changes in capacitance.

As discussed above, there are several applications that could make use of the capacitive touch communication technique of the present invention. With the current performance, the proposed technique can be directly applied to parental control applications, multi-user games and weak authentication for mobile devices. Further improvements in transmission rate and reliability would open up many other of applications. The implementations of the disclosed system are not limited in this regard.

User identification and authentication in many cellular networks has so far been based on SIM cards, essentially tokens directly inserted into a cellular phone. This was an adequate solution when people access the network through a single device. With access to diverse devices such as smart phones, laptops, tablets, and cars that may be shared among multiple users—who may be constantly on the move—it is becoming more important to understand which user is interacting with them at any given time. In addition, with shared data plans (shared across devices) data usage from any device could be charged toward user account instead of charging toward devices. That billing model can be realized by our proposed techniques in which the signet ring is used as a separate identification token, e.g. a portable SIM worn by users.

The ring can be used as a replacement for credit card (i.e. credit ring) for authenticating monetary transactions on mobile phones and ATM machines. At the same time, thanks to the pervasiveness of capacitive touch technology, the same ring could be used to access a smart-home where it would not only unlock the door but could also authorize access to and load user-specific preferences on all the user's devices in the house such as entertainment systems, home appliances.

A system, apparatus, and method transmitting information through a capacitive touch screen is disclosed. The method triggers touch events in the touch screen device by injecting an electric signal that affects the capacitance measurements of the screen. Transmission of information via small physical tokens can be used to distinguish who is interacting with a mobile device, and can be useful for parental control, multiuser games (particularly when played on a single device), and possibly play a role in authentication solutions. The disclosed implementations differ from other short-range communication systems in that it requires physical touch for communication, which can be an advantage if multiple potential users are so close that they cannot be differentiated with the other short-range systems. The technique could also be used to distinguish different devices touching the screen such as styluses or board game tokens. Significantly higher data rates could be achieved by designing receiver capabilities into touch screens.

The foregoing examples and description of various embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the following claims.

We claim:

1. A user device, comprising:
a circuit to generate a signal; and
at least one electrode electrically coupled to the circuit and configured to communicate the signal to an electronic device by varying a capacitance of a capacitive touch sensor of the electronic device.

2. The device according to claim 1, further comprising a memory having a data sequence stored therein.

3. The device according to claim 2, further comprising a processor configured to generate signal based on the data sequence stored in the memory.

4. The device according to claim 1, wherein the signal is modulated using frequency modulation.

5. The device according to claim 1, wherein the signal is modulated using amplitude modulation.

6. The device according to claim 5, wherein the wherein the amplitude modulation is on-off keying.

7. The device according to claim 1, further comprising a second electrode electrically coupled to the circuit configured to communicate the signal to the external device using a user's body as a communication medium, wherein the electrode is in contact with the user and the user is in contact with the capacitive touch screen.

8. A method for using a user device to communicate with a touch-sensor of an electronic device, the method comprising:
generating, by the user device, a signal encoding a data sequence;
communicating the signal from the user device, to the electronic device by varying a capacitance of the touch-screen thereof; and
receiving and decoding, by the electronic device, the signal to obtain the data sequence.

9. The method according to claim 8, further comprising identifying a user of the user device using the data sequence.

10. The method according to claim 8, further comprising authenticating a user of the user device using the data sequence.

11. The method according to claim 8, wherein the data sequence is stored on the electronic device, the method further comprising:
receiving, by the electronic device, a sequence of touch events generated in response to the signal;
training the electronic device by:
repeatedly transmitting, by the user device, the signal generated from the data sequence:
recording the sequence of touch events generated in response to the signal that is transmitted by the user device; and
aligning the sequence of touch events with the data sequence stored on the electronic device, wherein each bit of the data sequence is associated with a bit period that defines an amount of time during which the bit is transmitted.

12. The method according to claim 11, wherein aligning the sequence of touch events with the data sequence comprises, for each possible starting point in a first bit period:
counting a number of one-bit touch events, wherein a one-bit touch event is a touch event received in a bit period associated with a one bit;
counting a number of zero-bit touch events, wherein a zero-bit touch event is a touch event received in a bit period associated with a zero bit;
calculating a ratio of the number of one-bit touch events to the number of zero-bit touch events; and
selecting a starting point that results in the ratio being maximized.

13. The method according to claim 12, further comprising determining a touch event threshold based on the sequence of touch events, wherein the touch event threshold is the number of touch events that is least likely to occur in a bit period associated with either a zero bit or a one bit.

14. The method according to claim 13, further comprising:
on a condition that the number of touch events is greater than the touch event threshold, identifying the bit period as a one bit.

15. The method according to claim 14, further comprising:
on a condition that the number of touch events is less than the touch event threshold, identifying the bit period as a zero bit.

16. The method according to claim 8, wherein decoding the signal comprises:
receiving, by the electronic device, a sequence of touch events generated in response to the to the signal;
identifying a plurality of bit period sequences each having a unique starting position, and each bit period sequence comprising a plurality of bit periods;
for each bit period sequence, counting the number of events in each bit period;
generating a bit sequence for each bit period sequence by:
on a condition that the number of touch events is greater than a threshold, identifying the bit period as a one bit; and
on a condition that the number of touch events is less than a threshold, identifying the bit period as a zero bit;
comparing each bit sequence to a table of possible messages; and
selecting a message from the table that is most similar to the bit sequence.

17. A system for capacitive touch communication, the system comprising:
a first device comprising:
a signal generating circuit configured to generate a signal encoded with a data sequence; and
at least one electrode electrically coupled to the circuit and configured to communicate the modulated signal to a second device by varying a capacitance of a capacitive touch screen of the second device; and
the second device comprising:
a processor;
a capacitive touch sensor; and
a computer-readable storage medium storing instructions that, when executed, cause the processor to:
receive a sequence of touch events from the touch sensor generated in response to the varying capacitance of the capacitive touch-screen caused by the device; and
decode the sequence of touch events to obtain the encoded data sequence.

18. The system according to claim 17, wherein the data sequence is used by the second device to identify a user of the first device.

19. The system according to claim 17, wherein the first device further comprises a memory having the data sequence stored therein.

20. The system according to claim 19, where in the first device further comprises a processor configured to generate the signal by encoding the data sequence stored in the memory;

21. The system according to claim 17, wherein the instructions further cause the processor to:
receive a sequence of touch events generated in response to the signal;
record the sequence of touch events generated in response to the signal that is transmitted by the user device;
align the sequence of touch events with the data sequence stored on the electronic device, wherein each bit of the data sequence is associated with a bit period that define an amount of time during which the bit is transmitted;
for each possible starting point in a first bit period:
count a number of one-bit touch events, wherein a one-bit touch event is a touch event received in a bit period associated with a one bit;
count a number of zero-bit touch events, wherein a zero-bit touch event is a touch event received in a bit period associated with a zero bit;
calculate a ratio of the number of one-bit touch events to the number of zero-bit touch events; and
select a starting point that results in the ratio being maximized; and
determine a touch event threshold based on the sequence of touch events, wherein the touch event threshold is the number of touch events that is least likely to occur in a bit period associated with either a zero bit or a one bit.

23. The system according to claim 17, wherein the instructions further cause the processor to:
receiving, by the electronic device, a sequence of touch events generated in response to the to the modulated signal;
identifying a plurality of bit period sequences each having a unique starting position, and each bit period sequence comprising a plurality of bit periods;
for each bit period sequence, counting the number of events in each bit period;
generating a bit sequence for each bit period sequence by:
on a condition that the number of touch events is greater than a threshold, identifying the bit period as a one bit; and
on a condition that the number of touch events is less than a threshold, identifying the bit period as a zero bit;
comparing each bit sequence to a table of possible messages; and
selecting a message from the table that is most similar to the bit sequence.
